(19) United States
(12) Patent Application Publication
(10) Pub. No.: US 2017/0212912 A1
(43) Pub. Date: Jul. 27, 2017

(54) TELEMATICS TERMINAL, TELEMATICS SERVER, TELEMATICS SYSTEM, AND METHOD FOR CONTROLLING THE TELEMATICS TERMINAL, TELEMATICS SERVER AND TELEMATICS SYSTEM

(71) Applicant: HYUNDAI MOTOR COMPANY, Seoul (KR)

(72) Inventor: Chang Woo CHUN, Anyang-si (KR)

(21) Appl. No.: 15/353,272

(22) Filed: Nov. 16, 2016

(30) Foreign Application Priority Data
Jan. 25, 2016 (KR) 10-2016-0008543

(51) Int. Cl. G06F 17/30; G01S 19/13

(52) U.S. Cl. CPC G06F 17/30268; G06F 17/3028; G01S 19/13; H04L 67/12

(57) ABSTRACT

An in-vehicle telematics terminal includes a storage for storing a vehicle traveling image, a metadata generator for generating metadata of the vehicle traveling image, an index information generator for generating index information of the vehicle traveling image using the metadata of the vehicle traveling image, wherein the index information includes a traveling section and an image capture time corresponding to the traveling section, and a communication module for transmitting the generated index information to a telematics server or for transmitting some parts of the index information corresponding to a search condition requested by the telematics server.

### CROSS-REFERENCE TO RELATED APPLICATION

This application claims the benefit of priority to Korean Patent Application No. 10-2016-0008543, filed on Jan. 25, 2016 with the Korean Intellectual Property Office, the disclosure of which is incorporated herein by reference.

### TECHNICAL FIELD

Embodiments of the present disclosure relate to a telematics terminal (i.e., an in-vehicle telematics terminal) installed in a vehicle, a telematics server, a telematics system, and a method for controlling the telematics terminal, telematics server and telematics system.

### BACKGROUND

Telematics is a compound word of telecommunication and informatics, and is defined as a next-generation information provision service for vehicles implemented by combining Information Technology (IT) industries, in which wireless communication, vehicle terminals and content are organically associated with one another, and vehicle industries.

A telematics service can provide users with various services (for example, transportation and traveling information, emergency situation handling information, remote vehicle diagnosis service, Internet etc.) by combining wireless communication technology and Global Positioning System (GPS) technology.

In order to rapidly and efficiently perform the telematics service, rapid information search and efficient information sharing between the telematics terminal and the telematics service communicating with the telematics terminal are needed. In addition, the telematics terminal is installed in vehicles, such that the telematics terminal may be used as an in-vehicle telematics terminal.

### SUMMARY

Therefore, it is an aspect of the present disclosure to provide an in-vehicle telematics terminal for generating index information of a vehicle traveling image using metadata of the vehicle traveling image, and transmitting index information of the vehicle traveling image to a telematics server, and a method for controlling the same.

It is another aspect of the present disclosure to provide a telematics server for receiving a vehicle traveling image and index information of the vehicle traveling image from a plurality of in-vehicle telematics terminals, and storing the received vehicle traveling image, searching for the index information of the vehicle traveling image upon receiving a request of the vehicle traveling image from at least one of the plural telematics terminals, and transmitting the vehicle traveling image to one telematics terminal having generated the request, and a method for controlling the telematics server.

It is another aspect of the present disclosure to provide a telematics system including a telematics terminal embedded a vehicle and a telematics server, and a method for controlling the telematics system.

Additional aspects of the disclosure will be set forth in part in the description which follows and, in part, will be obvious from the description, or may be learned by practice of the disclosure.

Various embodiments of the present disclosure are directed to providing an in-vehicle telematics terminal installed in a vehicle, a telematics server, a telematics system, and a method for controlling the telematics system, that substantially obviate one or more problems due to limitations and disadvantages of the related art.

In accordance with an aspect of the present disclosure, an in-vehicle telematics terminal may include a storage configured to store a vehicle traveling image; a metadata generator configured to generate metadata of the vehicle traveling image; an index information generator configured to generate index information of the vehicle traveling image using the metadata of the vehicle traveling image, wherein the index information includes a traveling section and an image capture time corresponding to the traveling section; and a communication module configured to transmit the generated index information to a telematics server or to transmit some parts of the index information corresponding to a search condition requested by the telematics server.

The in-vehicle telematics terminal may include the metadata of the vehicle traveling image includes not only information regarding an image capture position of the vehicle traveling image but also information regarding an image capture time at which the vehicle traveling image is captured.

The in-vehicle telematics terminal may include the traveling section includes a road section between a first point and a second point where a vehicle travels.

The in-vehicle telematics terminal may include the image capture time includes date and time information during which the vehicle travels in the traveling section.

The in-vehicle telematics terminal may include the search condition includes some sections of the traveling section and an image capture time corresponding to the some sections.

In accordance with an aspect of the present disclosure, a telematics server may include an information transmission/reception (Tx/Rx) server configured to transmit and receive a vehicle traveling image and index information of the vehicle traveling image to and from a plurality of in-vehicle telematics terminals; an image storage configured to store the vehicle traveling image and index information of the vehicle traveling image; and an index information search module, upon receiving a search request for searching for some parts of the index information corresponding to a search condition from among the plurality of index information from at least one of the in-vehicle telematics terminals through the information transmission/reception (Tx/Rx) server, configured to search for the some parts of the index information.

The telematics server may include, if some parts of the index information corresponding to the search condition is searched for by the index information search module, the information transmission/reception (Tx/Rx) server transmits the vehicle traveling image corresponding to the searched some parts to at least one of the in-vehicle telematics terminals having generated the search request for searching for the some parts of the index information.

The telematics server may include, if some parts of the index information corresponding to the search condition are not searched for, the information transmission/reception (Tx/Rx) server is configured to transmit a transmission request for transmitting the vehicle traveling image corresponding to the some parts of the index information to at least one of the in-vehicle telematics terminals including the some parts of the index information.

The telematics server may include the index information of the vehicle traveling image includes index information of the vehicle traveling image, where the index information includes a traveling section and an image capture time corresponding to the traveling section.

The telematics server may include the traveling section includes a road section between a first point and a second point where a vehicle travels.

The telematics server may include the image capture time includes date and time information during which the vehicle travels in the traveling section.

The telematics server may include the search condition includes some sections of the traveling section and an image capture time corresponding to the some sections.

In accordance with an aspect of the present disclosure, a telematics system may include a plurality of in-vehicle telematics terminals configured to transmit and receive a vehicle traveling image and index information of the vehicle traveling image to and from a telematics server; and a telematics server configured to store the vehicle traveling image received from the plurality of in-vehicle telematics terminals and index information of the received vehicle traveling image, and configured to, upon receiving a transmission request for transmitting the vehicle traveling image and some parts of the index information of the vehicle traveling image from at least one of the in-vehicle telematics terminals, search for the some parts of the index information of the vehicle traveling image, and transmit the vehicle traveling image corresponding to the search result.

A method for controlling an in-vehicle telematics terminal may include storing a vehicle traveling image; generating metadata of the vehicle traveling image; generating index information of the vehicle traveling image using the metadata of the vehicle traveling image, wherein the index information includes a traveling section and an image capture time corresponding to the traveling section; and transmitting the generated index information to a telematics server, or transmitting some parts of the index information corresponding to a search condition requested by the telematics server.

The method may include the metadata of the vehicle traveling image includes not only information regarding an image capture position of the vehicle traveling image but also information regarding an image capture time at which the vehicle traveling image is captured.

The method may include the traveling section includes a road section between a first point and a second point where a vehicle travels.

The method may include the image capture time includes date and time information during which the vehicle travels in the traveling section.

The method may include the search condition includes some sections of the traveling section and an image capture time corresponding to the some sections.

A method for controlling a telematics server may include transmitting and receiving a vehicle traveling image and index information of the vehicle traveling image to and from a plurality of in-vehicle telematics terminals; storing the vehicle traveling image and index information of the vehicle traveling image; and upon receiving a search request for searching for some parts of the index information corresponding to a search condition from among the plurality of index information from at least one of the in-vehicle telematics terminals through the information transmission/reception (Tx/Rx) server, searching for the some parts of the index information.

The step of transmitting and receiving the vehicle traveling image and the index information of the vehicle traveling image includes, if some parts of the index information corresponding to the search condition are searched for, transmitting the vehicle traveling image corresponding to the searched some parts to at least one of the in-vehicle telematics terminals having generated the search request for searching for the some parts of the index information.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a conceptual diagram illustrating an overall network structure for use in a telematics system according to an embodiment of the present disclosure.

FIG. 2 is a view illustrating an in-vehicle telematics terminal and the external appearance of a vehicle including the in-vehicle telematics terminal according to an embodiment of the present disclosure.

FIG. 3 is a view illustrating an in-vehicle telematics terminal and an internal structure of a vehicle including the in-vehicle telematics terminal according to an embodiment of the present disclosure.

FIG. 4 is a block diagram illustrating an in-vehicle telematics terminal according to an embodiment of the present disclosure.

FIG. 5 is a block diagram illustrating a telematics server according to an embodiment of the present disclosure.

FIG. 6 is a flowchart illustrating a method for controlling an in-vehicle telematics terminal according to an embodiment of the present disclosure.

FIG. 7 is a flowchart illustrating a method for controlling a telematics server according to embodiments of the present disclosure.

FIG. 8 is a conceptual diagram illustrating a traveling section of an index information of a vehicle traveling image according to embodiments of the present disclosure.

FIG. 9 is a table illustrating metadata of a vehicle traveling images stored in an in-vehicle telematics terminal and a telematics server according to embodiments of the present disclosure.

FIG. 10 is a table illustrating index information communicated between an in-vehicle telematics terminal and a telematics server according to an embodiment of the present disclosure.

### DETAILED DESCRIPTION

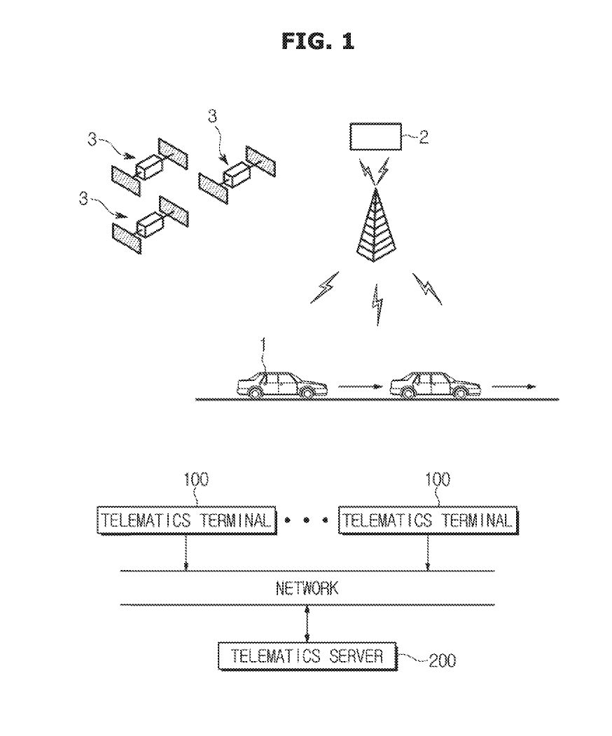

Reference will now be made in detail to the embodiments of the present disclosure, examples of which are illustrated in the accompanying drawings, wherein like reference numerals refer to like elements throughout. An in-vehicle telematics terminal, an in-vehicle telematics server, a telematics system, and a method for controlling the same according to embodiments of the present disclosure will hereinafter be described with reference to FIGS. 1 to 10.

FIG. 1 is a conceptual diagram illustrating an overall network structure for use in a telematics system according to an embodiment of the present disclosure.

Referring to FIG. 1, the telematics system according to an embodiment of the present disclosure may include a telematics terminal 100 contained in a vehicle 1 and a telematics server 200 contained in a telematics center 2.

Although the telematics terminal 100 according to the following embodiments is exemplarily set to an in-vehicle telematics terminal 100 installed in the vehicle 1 for convenience of description, the scope of the telematics terminal 100 is not limited thereto, and the telematics terminal 100 may include various kinds of terminals capable of communicating with the telematics server 200. For example, a mobile communication terminal (e.g., a mobile phone, a mobile terminal, etc.) communicating with the telematics server 200 may include a mobile phone, a smartphone, a laptop, a digital broadcast terminal, a Personal Digital Assistant (PDA), a Portable Multimedia Player (PMP), etc. The telematics terminal 100 may refer to an in-vehicle telematics terminal.

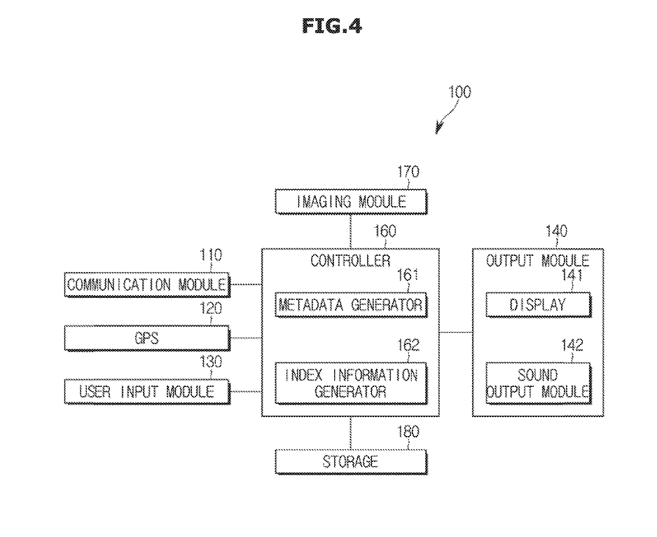

The telematics terminal 100 may receive GPS signals from at least three GPS satellites 3, and may calculate a current position of the vehicle 1 on the basis of GPS signal map data. In addition, the telematics terminal 100 may transmit map-based position information of the vehicle 1 to the telematics server 200 on the condition that a desired route from the current position of the vehicle 1 to a destination is established. In addition, the telematics terminal 100 may transmit not only a vehicle traveling image captured by a black box or other imaging devices, but also the vehicle traveling image stored in the storage 180 to the telematics server 200. In addition, the telematics terminal 100 may transmit index information of the vehicle traveling image and various other information. The telematics terminal 100 may receive the vehicle traveling image stored in the telematics server 200, index information of the vehicle traveling image, and various other information from the telematics server 200, and may transmit a transmission request regarding the above-mentioned information to the telematics server 200. In addition, the telematics terminal may request a vehicle traveling image of the telematics terminal 100 of another vehicle 1 and index information of the requested traveling information through the telematics server 200. In addition, the telematics terminal 100 may include various constituent elements, and each constituent element may perform various operations. The constituent elements and operations of the telematics terminal 100 will hereinafter be described with reference to FIG. 4.

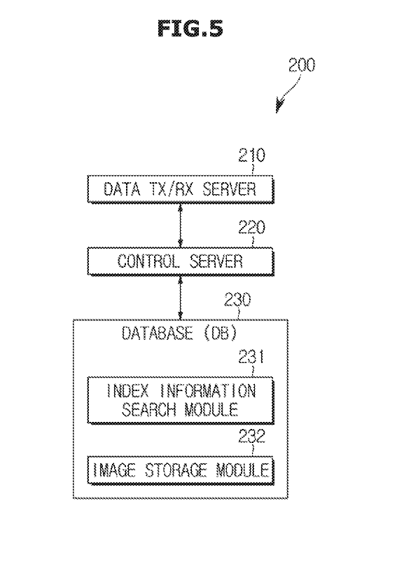

The telematics server 200 may receive the vehicle traveling image from the in-vehicle telematics terminal, index information of the vehicle traveling image, and various other information, and store the received information. In addition, the telematics server 200 may receive the vehicle traveling image received from the in-vehicle telematics terminal 100, index information regarding the vehicle traveling image, the vehicle traveling image stored in the database (DB) of the telematics server 200, and index information regarding the vehicle traveling image to at least one of the telematics terminals 100 contained in the plurality of vehicles 1. In addition, the telematics server 200 may transmit a transmission request regarding the vehicle traveling image stored in each storage 180 and index information of the stored vehicle traveling image from at least one of the telematics terminals 100 contained in the plurality of vehicles 1. In addition, the telematics server 200 may include various constituent elements, and each constituent element may perform various operations. The constituent elements and operations of the telematics server 200 will hereinafter be described with reference to FIG. 5.

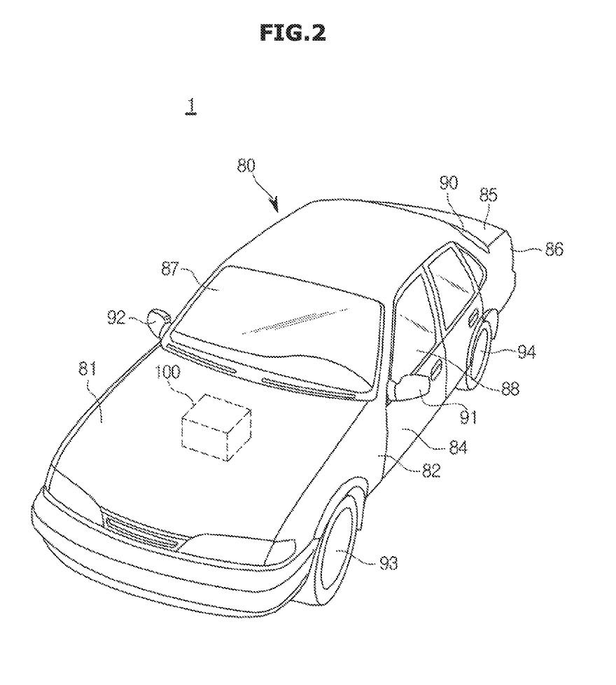

FIG. 2 is a view illustrating an in-vehicle telematics terminal and an external appearance of a vehicle including the in-vehicle telematics terminal according to an embodiment of the present disclosure.

Referring to FIG. 2, the vehicle 1 may include a main body 80 forming the appearance of the vehicle 1, front wheels 93 and rear wheels 94 to move the vehicle from place to place. In addition, the vehicle 1 may include a telematics terminal 100 contained in the vehicle 1. Although the telematics terminal 100 is denoted by dotted lines in a bonnet of the vehicle 1 for convenience of description, and the scope of the present disclosure is not limited thereto. The telematics terminal 100 is integrated with an Audio Video Navigation (AVN) device such that the AVN device including the telematics terminal 100 may be installed in an indoor unit of the vehicle 1.

Alternatively, the telematics terminal 100 may include an imaging module (such as a black box device) capable of performing image recording, such that the resultant telematics terminal 100 may be installed inside or outside the vehicle 1. In this way, the telematics terminal 100 may be installed at the interior of the vehicle 1 or at the indoor space of the vehicle 1 in various ways. In this case, the telematics terminal 100 is electrically connected to a camera installed at the outside of the vehicle 1, such that the telematics terminal 100 installed at the interior of the vehicle 1 may capture the vehicle traveling image or the like.

The main body 80 of the vehicle may include a hood 81, a front fender 82, a door 84, a trunk lid 85, and a quarter panel 86, etc. In addition, a front window glass (also referred to as a vehicle windshield) 87 installed at the front of the main body 80 so as to provide a forward view of the vehicle 1 to a vehicle driver who rides in the vehicle 1, a side window glass 88 to provide a side view of the vehicle 1 to the vehicle driver, side-view mirrors (91, 92) installed at the door 84 so as to provide a rear view and a side view of the vehicle 1 and a rear window glass 90 installed at the rear of the main body 80 so as to provide a rear view of the vehicle 1 may be provided at the outside of the main body 80.

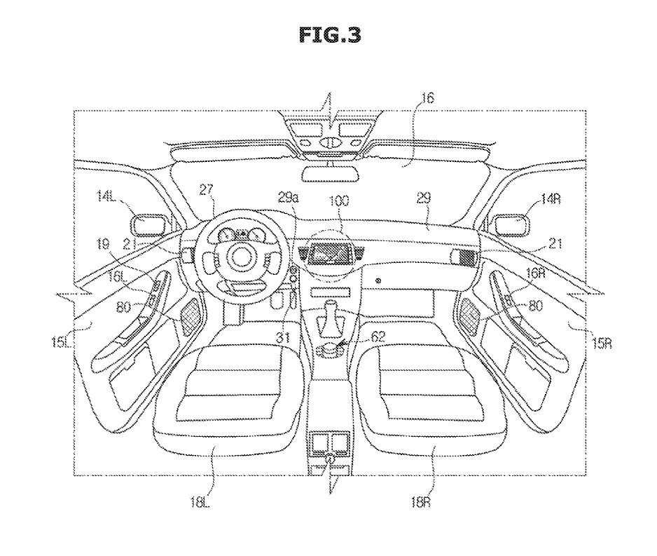

FIG. 3 is a view illustrating an in-vehicle telematics terminal and an internal structure of a vehicle including the in-vehicle telematics terminal according to an embodiment of the present disclosure.

Referring to FIG. 3, the telematics terminal 100 may be installed at an interior of the vehicle 1 in the center region of the dashboard 29. Referring to FIG. 3, the telematics terminal 100 may include an Audio Video Navigation (AVN) device and an AVN input module. In addition, the telematics terminal 100 may selectively display at least one of an audio image, a video image, and a navigation image, and may display various control images related to the vehicle 1 or other images related to additional functions. In addition, the telematics terminal 100 may output the vehicle traveling image stored in the storage 180 of the telematics terminal 100 through the display screen. In addition, the telematics terminal 100 may output the vehicle traveling image received from the telematics server 200 through the display screen.

The display screen of the telematics terminal 100 may be implemented as any one of a Liquid Crystal Display (LCD) panel, a Light Emitting Diode (LED) panel, an Organic Light Emitting Diode (OLED) panel and a Cathode Ray Tube (CRT), etc.

The input module of the telematics terminal 100 formed in a hard key shape may be mounted to one region adjacent to the display screen of the telematics terminal 100. If the input module of the telematics terminal 100 is implemented as a touchscreen, the input module of the telematics terminal 100 may also be implemented as a touch panel at the front surface of the telematics terminal 100. The input module of the telematics terminal 100 may be implemented as a jog-wheel center input module 62 located between a driver seat 18L and a passenger seat 18R. The user may input a control command to the telematics terminal 100 by moving the center input module 62 forward or backward and to the left or right or by pressing or turning the center input module 62.

The vehicle 1 may include a sound output unit 142 to output the acoustic or sound signal. The sound output unit 142 may be implemented as a speaker. The sound output unit 142 may output the acoustic or sound signal needed to perform the audio function, the video function, the navigation function, and other additional functions.

For example, the sound output unit 142 may be respectively mounted to a left door 15L and a right door 15R. If necessary, the sound output unit 142 may also be mounted to other regions, for example, doors of the rear seat, the dashboard 29, etc.

The steering wheel 27 may be mounted to the dashboard 29 located adjacent to the driver seat 18L, and a keyhole 29a in which the smart key (e.g., a key fob) can be inserted may be formed close to the steering wheel 27. If the smart key is inserted into the keyhole 29a and authentication between the smart key and the vehicle 1 is completed over a wireless communication network, the smart key can communicate with the vehicle 1.

In addition, the dashboard 29 may include a start button 31 to turn the vehicle 1 on or off. The smart key may be inserted into the keyhole 29a. If authentication between the smart key and the vehicle 1 is completed over the wireless communication network, the vehicle 1 starts when the user pushes the start button 31.

The vehicle 1 may include an air-conditioner configured to perform a heating and cooling function, and may control air temperature of the internal space of the vehicle 10 by discharging the heated or cooled air through the air outlet 21.

A window adjustment module 16R may be installed at the right door 15R, and a window adjustment module 16L may be installed at the left door 15L. The user may roll up or down vehicle windows using the window adjustment modules (16R, 16L).

A side-view mirror adjustment module 19 may include a direction adjustment button installed at the vehicle door 15L adjacent to the driver seat in a manner that side-view mirrors can be adjusted according to the driver's eyes, and folding/unfolding buttons configured to fold the side-view mirrors in a window direction of the vehicle or to unfold the side-view mirrors in an opposite direction of the vehicle window are provided. Therefore, the user may adjust a first side-view mirror and a second side-view mirror 14R according to the driver's eyes using the direction adjustment button of the side-view mirror adjustment module 19. In addition, the user can fold or unfold the first side-view mirror 14L and the second side-view mirror 14R using the folding or unfolding button.

FIG. 4 is a block diagram illustrating a telematics terminal (i.e., in-vehicle telematics terminal) installed in a vehicle according to an embodiment of the present disclosure.

Referring to FIG. 4, the telematics terminal 100 may include a communication module 110, a GPS 120, a user input module 130, an output module 140, a controller 160, an imaging module 170, and a storage 180. When the above-mentioned constituent elements are implemented in an actual application, two or more constituent elements may be integrated into one element, or one constituent element may be classified into two or more constituent elements as necessary.

The communication module 110 may transmit and receive the vehicle traveling image and index information of the vehicle traveling image to and from the telematics server 200 over a wired or wireless network. Here, the wired or wireless network may include a wireless Internet, a wireless telephone network, a wireless local area network (WLAN), a Wireless Fidelity (Wi-Fi) network, a 3^{rd} generation (3G) network, a 4^{th} generation (4G) Long Term Evolution (LTE) network, a Bluetooth network, a Radio Frequency Identification (RFID) network, an Infrared Data Association (IrDA) network, a ZigBee network, an Ultra Wideband (UWB) network and a Near Field Communication (NFC) network.

In addition, the communication module 110 may transmit the vehicle traveling image stored in the storage of the telematics terminal 100 and index information regarding the stored vehicle traveling image to the telematics server 100. In addition, upon receiving a request signal for requesting a vehicle traveling image of a specific section and index information regarding the vehicle traveling image from the telematics server 100, the communication module 110 may transmit the requested vehicle traveling image and index information regarding the requested vehicle traveling image.

In addition, the communication module 110 may transmit a transmission request signal for receiving a vehicle traveling image of a specific section stored in the telematics server 100 and index information regarding the vehicle traveling image of the specific section to the telematics server 100. In addition, the communication module 110 may transmit index information of the vehicle traveling image generated by an index information generator 162 to be described later, or may transmit some parts of index information corresponding to the search condition requested from the telematics server 100.

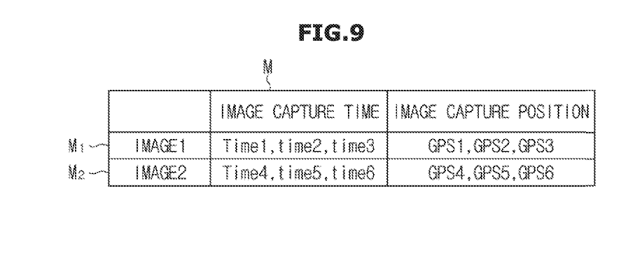

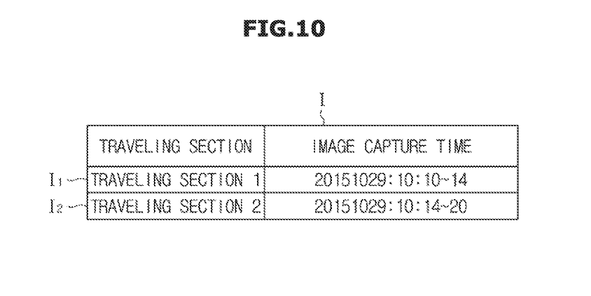

The GPS 120 may receive a GPS signal from at least three satellites, and may calculate position information of the vehicle 1. The position information may include coordinate information denoted by latitude and longitude lines. In addition, the position information of the vehicle 1 may be mapped to a map stored in the storage 180, may be displayed through the output module 140 and may then be stored in the storage 180. In addition, the position information may be configured in metadata along with the vehicle traveling image, and stored in the storage 180 of the telematics terminal 100. A detailed description thereof will hereinafter be described with reference to FIGS. 9 and 10. The position information may also be transmitted to the telematics server 200 through the communication module 110.

The user input module 130 may generate input data for allowing the user to control the operation of the telematics terminal 100. The user input module 130 may be implemented as a touchpad, a keypad and/or a jog-wheel, etc. Specifically, if the touchpad and the display 141 to be described later construct a mutual layer structure, this layer structure will hereinafter be referred to as a touchscreen.

The user may select a destination through the user input module 130, and may establish a desired traveling route. In addition, the user may input a command through the user input module 130 so as to transmit a transmission request of the vehicle traveling image stored in the storage 130 and index information of the vehicle traveling image to the telematics server 200. In addition, the user may input a reception request command through the user input module 130 so as to receive the vehicle traveling image and index information of the vehicle traveling image from the telematics server 200. In addition, the user may input a search condition through the user input module 130 so as to recognize whether the telematics server 200 stores a specific vehicle traveling image and some parts of index information of the specific vehicle traveling image, such that the user may transmit a search request for searching for some parts of the index information.

The output module 140 may be used to generate an output signal related to the visual or auditory sense, and may include a display 141 and a sound output module 143.

The display 141 may display information processed by the telematics terminal 100. For example, if the telematics terminal 100 is in a navigation mode, the display 141 may display a User Interface (UI) or a Graphic User Interface (GUI).

The display 141 may output the vehicle traveling image stored in the storage 180 of the telematics terminal 100, or may output the vehicle traveling image received from the telematics server 200. The display 141 may be implemented by any one of a liquid crystal display (LCD) panel, a thin film transistor—liquid crystal display (TFT-LCD) panel, a light emitting diode (LED) panel, an organic light emitting diode (OLED) panel, a flexible display and/or a 3D display, etc., without being limited thereto.

If the display 141 and the sensor configured to sense the touch operation construct a mutual layer structure, the display 141 may also be used not only as the output device but also as the input device.

The sound output module 142 may output audio data received from the communication module 110 or stored in the storage 180. The sound output module 142 may output an acoustic or sound signal related to functions (e.g., navigation function) executed in the telematics terminal 100. The sound output module 142 may include a receiver, a speaker, a buzzer, etc.

The controller 160 may control an overall operation of the telematics terminal 100, and may be implemented as one or more microprocessors configured to operate by an established program. The established program may include a series of commands for performing individual steps contained in the method for transmitting/receiving information between the in-vehicle telematics terminal 100 and the telematics server 200 according to the following embodiment. In addition, the controller 160 may transmit the above-mentioned constituent elements and a control command related to the following constituent elements (to be described later) using electrical signaling, and may be connected to the respective constituent elements over a wired or wireless communication network such that the constituent elements can be mutually controlled. For example, the controller 160 may control the communication module 110 to transmit a request signal for requesting the vehicle traveling image and index information of the vehicle traveling image to the telematics server 200.

The controller 160 may include a metadata generator 161 and an index information generator 162.

The metadata generator 161 may generate metadata of the vehicle traveling image acquired through the imaging module 170. In addition, the metadata generator 161 may generate metadata of the vehicle traveling image stored in the storage 180.

When the images are captured or imaged, the metadata of the vehicle traveling image described in the present disclosure may indicate various kinds of information stored in the storage along with the images. In addition, the metadata may include not only information regarding the capture position of the vehicle traveling image and information regarding the capture time of the vehicle traveling image. The metadata may further include not only a traveling section in which the vehicle traveling image is imaged or captured, but also information regarding a traveling time needed for the traveling section.

In addition, the metadata of the vehicle traveling image generated by the metadata information generator 161 may be used to generate index information of the vehicle traveling image. In addition, the metadata of the vehicle traveling image may be constructed as a table-shaped database (DB) shape and stored in a database 230 of the telematics server 200.

Referring to FIG. 9, for example, it is assumed that the vehicle traveling image may include a first image (IMAGE 1) and a second image (IMAGE 2), and it is also assumed that metadata (M) of the vehicle traveling image may include two kinds of metadata (i.e., metadata M1 of the first image (IMAGE1) and metadata M2 of the second image (IMAGE2)) related to two vehicle traveling images (IMAGE1, IMAGE2). Of course, the scope or spirit of the present disclosure is not limited thereto, and the metadata may further include other metadata related to a plurality of vehicle traveling images.

In more detail, the first image (IMAGE1) may include metadata M1 that includes image captured positions (GPS1 to GPS3) and image captured times (Time1 to Time3). The second image (IMAGE2) may include metadata M2 that includes image captured positions (GPS4 to GPS6) and image captured times (Time4 to Time6). In addition, the vehicle traveling image may include other metadata (not shown in Table of FIG. 9) that indicates a unique number of the telematics terminal 100 or a unique number of the vehicle 1 having performed the image capture.

In addition, the operation for storing such metadata in the vehicle traveling image may include receiving an image capture time obtained from the imaging module 170, the position information obtained from the GPS 120, and the setting information stored in the storage 180, and simultaneously storing the received information and the image is well known to those skilled in the art, and as such a detailed description thereof will herein be omitted for convenience of description. The metadata of the vehicle traveling image may also be stored in a DB module 232 of the telematics server 200.

The index information generator 162 may generate the vehicle traveling image captured by the imaging module 170, the vehicle traveling image stored in the storage 180, and index information regarding the vehicle traveling image received from the telematics server 200.

In more detail, the index information generator 162 may generate index information (see ‘I’ of FIG. 10) of the vehicle traveling image including not only a vehicle traveling section but also an image capture time obtained during the vehicle traveling section, using metadata (see ‘M’ of FIG. 9) of the vehicle traveling image generated by the metadata generator 161. In this case, the traveling section may indicate a road section ranging from a first point to a second point such that the vehicle 1 travels in the road section.

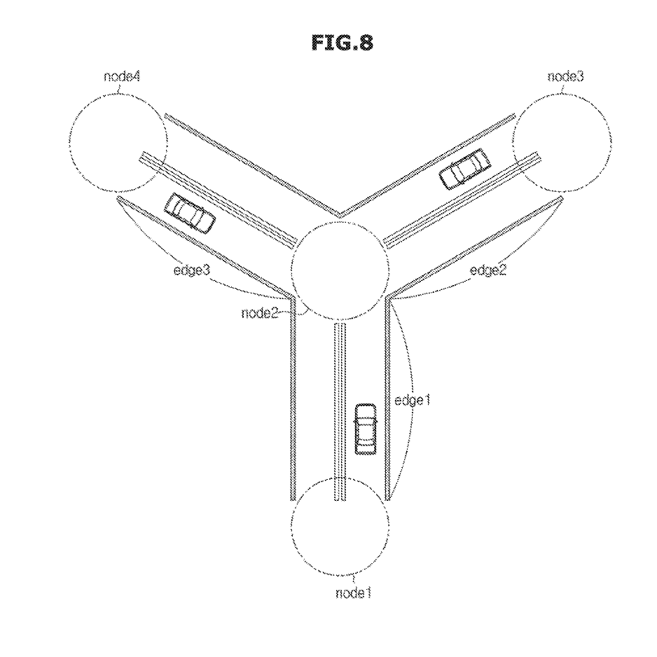

Referring to FIGS. 8 and 9, each of a plurality of nodes (Node1 to Node4) may be an arbitrary point on the map. The edges (Edge1 to Edge3) among the nodes (Node1 to Node4) may be the traveling sections of the vehicle 1. The node on the map for use in the embodiment may be defined as an arbitrary point on the map, and the edge on the map may be defined as a traveling section. Therefore, the vehicle traveling image for use in the embodiment may indicate a traveling image of the vehicle that travels in the traveling sections (Edge1 to Edge3) illustrated in FIG. 8.

The index information may be generated on the basis of metadata of the vehicle traveling image, and may be used as a predetermined reference for classifying the vehicle traveling image.

Referring to FIG. 10, the vehicle traveling image may be classified or indexed according to respective traveling sections, on the basis of not only the image capture position information used in metadata of the vehicle traveling image, but also the image capture time information corresponding to the image capture position information.

For example, assuming that the road section (i.e., Edge1 of FIG. 8) between the first point (Node1) and the second point (Node2) on the map is set to a first traveling section (Traveling Section 1), and the road section (i.e., Edge2 of FIG. 8) between the second point (Node2) and the third point (Node3) on the map is set to a second traveling section (Traveling Section 2), index information (I) of the vehicle traveling image may include first index information (I1) that includes the first traveling section (Traveling Section 1) and an image capture time (20151029:10:10˜14) corresponding to the first traveling section (Traveling Section 1), and may further include second index information (I2) that includes the second traveling section (Traveling Section 2) and an image capture time (20151029:10:14˜20) corresponding to the second traveling section (Traveling Section 2). In addition, the image capture time may include date and time information during which the vehicle 1 runs or travels in the traveling section. That is, for example, if the image capture time is denoted by 20151029:10:10˜14, this means that the image capture time ranges from 29 Oct. 2015, 10:10 (AM) to 29 October 2015, 10:14 (AM).

For convenience of description, the vehicle traveling image is divided into only two sections, i.e., a first traveling section (Traveling Section 1) and a second traveling section (Traveling Section 2). If necessary, the vehicle traveling image may also be divided into two or more traveling sections. Although the index information (I) refers to only some index information (I1, I2) for convenience of description, the index information (1) may include much more index information according to the vehicle traveling image.

The index information generator 162 may generate a traveling section and index information including an image capture time corresponding to the traveling section as described above. Therefore, when the in-vehicle telematics terminal 100 attempts to transmit the vehicle traveling image requested by the telematics server 200 to the in-vehicle telematics server 200, the index information generator 162 allows the telematics terminal 100 to perform a search function using only some parts of the index information of the vehicle traveling image so as to determine whether the vehicle traveling image is matched to the search condition. As a result, the in-vehicle telematics server 200 can rapidly search for the requested vehicle traveling image according to the determined result.

The search condition for use in the embodiment may indicate not only some sections from among the plurality of sections on which the vehicle travels, but also the image capture time obtained by the vehicle traveling in the some sections. For example, assuming that the search condition includes “BangBang street” (indicating the traveling section) and “29 Oct. 2015, 10:00 AM to 29 Oct. 2015, 11:00 AM” (indicating the image capture time), the in-vehicle telematics terminal 100 and the telematics server 200 may search for the vehicle traveling image corresponding to the above search condition and may transmit and receive the retrieved vehicle traveling image.

The telematics terminal 100 may further include an imaging module 170. The imaging module 170 may process image frames, for example, still images or moving images, obtained by image sensors during an image capture mode. In addition, the imaging module 170 may image a front-view image and a rear-view image (i.e., the vehicle traveling image) regarding the vehicle traveling direction. In addition, the image frames processed by the imaging module 170 may be stored in the storage 180, or may be transmitted to the telematics server 200 through the communication module 110. In addition, the imaging module 170 may be a black box camera installed in the vehicle 1.

The storage 180 may store the vehicle traveling image acquired by the imaging module 170. In addition, the telematics server 200 may store the vehicle traveling image received from the telematics server 200. In addition, the storage 180 may store metadata of the vehicle traveling image generated by the other information generator 161. In addition, the storage 180 may store index information of the vehicle traveling image generated by the index information generator 162. In addition, the storage 180 may store the program for operating the controller 160, and may store input/output (I/O) data (e.g., still images, moving images, etc.). In addition, the storage 180 may store map data for navigation.

The storage 180 may be configured as at least one of a flash memory type, a hard disk type, a multimedia card micro type, a card type memory (e.g. a Secure Digital (SD) memory or an eXtreme Digital (XD) memory), a Random Access Memory (RAM), a Read Only Memory (ROM), an Electrically Erasable Programmable Read Only Memory (EEPROM), a Programmable Read Only Memory (PROM), a magnetic memory, a magnetic disc and/or an optical disc, etc. The telematics terminal 100 may operate in relation to a web storage configured to perform a storage function of the storage 180 on the Internet.

FIG. 5 is a block diagram illustrating a telematics server according to an embodiment of the present disclosure.

Referring to FIG. 5, the telematics server 200 may include an information transmission/reception (Tx/Rx) server 210, a control server 220 and a database 230. When the above-mentioned constituent elements are implemented in an actual application, two or more constituent elements may be integrated into one element, or one constituent element may be classified into two or more constituent elements as necessary.

The information Tx/Rx server 210 may receive information from the plurality of in-vehicle telematics terminals over the network, or transmit information to the plurality of in-vehicle telematics terminals over the network.

In more detail, the information Tx/Rx server 210 may receive the vehicle traveling image and index information of the vehicle traveling image from the plurality of in-vehicle telematics terminals 100. In addition, if the information Tx/Rx server 210 receives a transmission request for the vehicle traveling image and index information regarding the vehicle traveling image from at least one in-vehicle telematics terminal 100 from among the plurality of in-vehicle telematics terminals 100, the information Tx/Rx server 210 may transmit the requested vehicle traveling image and associated index information.

In addition, assuming that the index information search module 231 searches for some parts of the index information of the vehicle traveling image corresponding to the search condition, the information Tx/Rx server 210 may transmit the vehicle traveling image corresponding to the searched parts to at least one of the plurality of in-vehicle telematics terminals 100 each having requested some parts of the index information.

In addition, assuming that some parts of the index information of the vehicle traveling image corresponding to the search condition are not searched by the index information search module 231, the information Tx/Rx server 210 may output a transmission request for transmitting the vehicle traveling image corresponding to some parts of the index information to at least one of the in-vehicle telematics terminals 100 each having some parts of the index information.

The control server 220 may control the information Tx/Rx server 210 and the database 230. In addition, the control server 220 may receive a search request for searching for the vehicle traveling image and index information of the vehicle traveling image from the information Tx/Rx server 210, and may transmit the received information to the database 230 through electric control signaling or through a wireless communication network.

The database 230 may include an index information search module 231 and an information storage 232. In addition, the database 230 may store the vehicle traveling image received from the plurality of in-vehicle telematics terminals 100 and index information regarding the vehicle traveling image. In addition, the database 230 may store information regarding an overall setting of the telematics server 200.

Upon receiving a search command for searching for some parts of the index information of the vehicle traveling image from the control server 220, the index information search module 231 may search for index information regarding the vehicle traveling image stored in the image storage 232.

In more detail, upon receiving a search request for searching for some parts of the index information of the vehicle traveling image corresponding to the search condition from at least one of the plurality of in-vehicle telematics terminals 100 through the information Tx/Rx server 200, the index information search module 231 may search for index information of the vehicle traveling image stored in the image storage 232, and may thus determine the presence or absence of a vehicle traveling image identical to some parts of the requested index information.

In this case, the search condition may indicate an image of a specific traveling section requested by the in-vehicle telematics terminal 100 and an image capture time corresponding to the specific traveling section image. Referring to FIG. 8, not only a vehicle traveling image obtained when the vehicle travels in a specific traveling section (Edge1) from among the plurality of traveling sections (Edge1 to Edge3), but also the image capture time obtained when the vehicle travels in the traveling section (Edge1) may be set to the search condition. A detailed description thereof has already been disclosed, such that it will now be omitted.

Therefore, assuming that the in-vehicle telematics terminal 100 receives not only information indicating the presence or absence of a vehicle traveling image corresponding to the above-mentioned search condition, but also a search request for searching for some parts of index information regarding the vehicle traveling image from the telematics server 200, the index information of the vehicle traveling image stored in the storage 180 of the in-vehicle telematics terminal 100 is searched for and the presence or absence of the vehicle traveling image corresponding to some parts of the requested index information can be rapidly determined.

In addition, if the presence of the vehicle traveling image corresponding to the search condition is determined according to the search result of some index information, the in-vehicle telematics terminal 100 may transmit the vehicle traveling image to the telematics server 200 through the communication module 110.

In addition, the above-mentioned processes may also be achieved by the telematics server 200. In more detail, assuming that the telematics server 200 receives not only information indicating the presence or absence of a vehicle traveling image corresponding to the above-mentioned search condition, but also a search request for searching for some parts of index information regarding the vehicle traveling image from at least one of the in-vehicle telematics server terminals 100, the index information of the vehicle traveling image stored in the image storage 232 of the telematics server 200 is searched for and the presence or absence of the vehicle traveling image corresponding to some parts of the requested index information can be rapidly determined.

In addition, if the presence of the vehicle traveling image corresponding to the search condition is determined according to the search result of some index information, the telematics server 200 may transmit the vehicle traveling image to at least one (having requested the vehicle traveling image) of the in-vehicle telematics terminals 100 through the information Tx/Rx server 210.

The information storage 232 may store the vehicle traveling image received from the in-vehicle telematics terminals 100 and index information regarding the vehicle traveling image.

The telematics system may include a telematics terminal 100 and a telematics server 200.

In more detail, the telematics system may include a plurality of in-vehicle telematics terminals 100 configured to transmit and receive the vehicle traveling image and index information regarding the vehicle traveling image to and from the telematics server 200. In addition, the telematics system may include the telematics server 200. Here, the telematics server 200 stores the vehicle traveling image received from the plurality of in-vehicle telematics terminals 100 and index information regarding the vehicle traveling image. Upon receiving a transmission request for transmitting a vehicle traveling image and index information regarding the vehicle traveling image from at least one of the in-vehicle telematics terminals 100, the telematics server 200 may transmit the transmission request to the in-vehicle telematics terminal 100 having generated the transmission request.

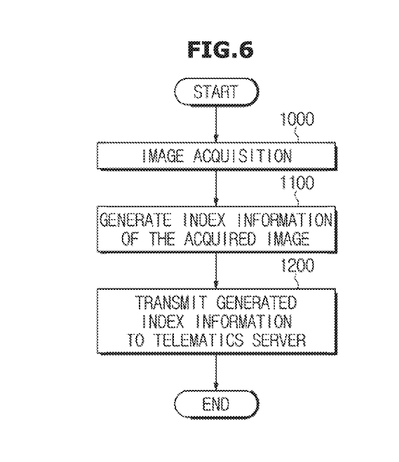

FIG. 6 is a flowchart illustrating a method for controlling an in-vehicle telematics terminal according to an embodiment of the present disclosure. A method for controlling the in-vehicle telematics terminal 100 will hereinafter be described.

Although the following operations may be achieved by constituent elements (e.g., a communication module 110, a controller 160, etc.) of the in-vehicle telematics terminal 100, a detailed description thereof has already been disclosed in FIG. 4, and the scope or spirit of the present disclosure is not limited thereto, such that it is assumed that the operations illustrated in FIG. 6 are identical to the operations of the in-vehicle telematics terminal 100 for convenience of description.

The in-vehicle telematics terminal 100 may acquire front-view and rear-view vehicle traveling images captured in forward and backward directions of the traveling direction of the vehicle captured by the image capture device (e.g., a camera installed outside the vehicle, a black box, or the imaging module 170) in operation 1000. In addition, the in-vehicle telematics terminal 100 may acquire the vehicle traveling image from the external device or the telematics server 200 through the communication module 110. The obtained vehicle traveling image may also be stored in the storage 180.

In addition, the in-vehicle telematics terminal 100 may generate index information of the vehicle traveling image obtained through the index information generator 162 in operation 1100.

In more detail, the in-vehicle telematics terminal 100 may acquire metadata of the vehicle traveling image obtained using the metadata generator 161.

FIG. 8 is a conceptual diagram illustrating a traveling section for use in index information of the vehicle traveling image. FIG. 9 is a table illustrating metadata of the vehicle traveling images stored in the in-vehicle telematics terminal and the telematics server. Assuming that the image captured when the vehicle 1 travels in a specific traveling section (Edge1) from among the plurality of traveling sections (Edge1 to Edge3) on the map is denoted by the first image (Image1), the image captured when the vehicle 1 travels in another traveling section (Edge2) is denoted by the second image (Image2). In addition, the table illustrated in FIG. 9 is an example of metadata (M) of the entirety of the vehicle traveling image, the first image (Image1) may include metadata M1 that includes the image capture positions (GPS1 to GPS3) and the image capture times (Time1 to Time3) corresponding to the image capture positions (GPS1 to GPS3). The second image (Image2) may include metadata M2 that includes the image capture positions (GPS4 to GPS6) and the image capture times (Time4 to Time6).

Although the metadata (M) of the vehicle traveling image is classified into first metadata (M1) of the first image (Image1) and second metadata (M2) of the second image (Image2) for convenience of description, the scope or spirit of the present disclosure is not limited thereto, the metadata (M) can also be classified into much more metadata according to the number of vehicle traveling images.

The in-vehicle telematics terminal 100 may generate index information of the vehicle traveling image using the image capture time of the above-mentioned metadata and the information regarding the image capture time. Referring to FIGS. 8 and 10, a first traveling section (Traveling Section 1) and a second traveling section (Traveling Section 2) may indicate a road section (Edge1) between the first point (Node1) and the second section (Node2) and a road section (Edge2) between the second point (Node2) and the third point (Node3), respectively. Index information (I) of the entire vehicle traveling image may include first index information (I1) of the vehicle traveling image of the first traveling section (Traveling Section 1) and second index information (I2) of the vehicle traveling image of the second traveling section (Traveling Section 2). Each index information (I1 or I2) may include a vehicle traveling section and an image capture time corresponding to the vehicle traveling section.

The in-vehicle telematics terminal 100 may generate index information of the vehicle traveling image and may transmit the generated index information to the telematics server 200 in operation 1200. In addition, the in-vehicle telematics terminal 100 may transmit the vehicle traveling image to the telematics server 200. Upon receiving a request for searching for index information of a specific vehicle traveling image from the telematics server 200, the in-vehicle telematics terminal 100 may search for index information according to the search condition, and may transmit the vehicle traveling image corresponding to the searched index information to the telematics server 200.

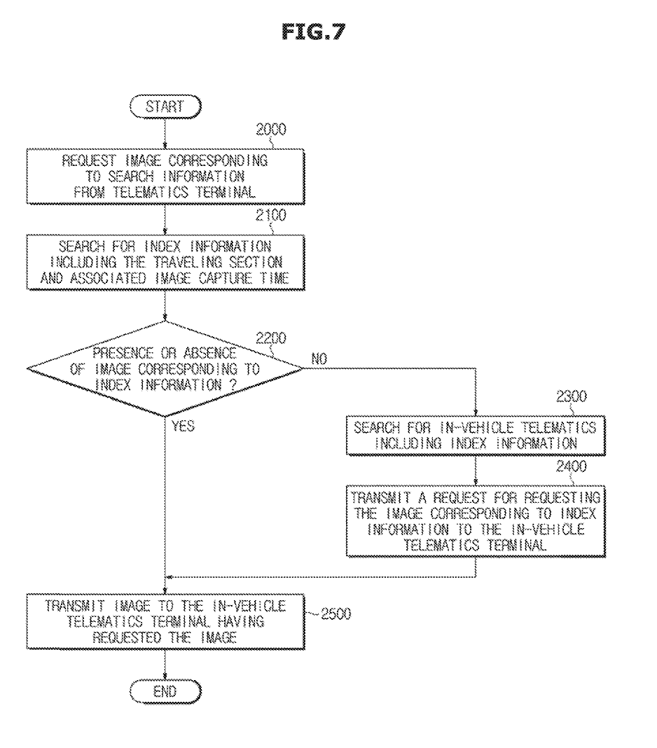

FIG. 7 is a flowchart illustrating a method for controlling a telematics server.

If at least one of the plurality of in-vehicle telematics terminals 100 attempts to acquire a vehicle traveling image of a specific vehicle instead of a vehicle traveling image associated with a current vehicle, or to acquire a vehicle traveling image of a specific accidental scene, and if this vehicle traveling image is not stored in the storage 180 or it is impossible to image the vehicle traveling image using the imaging module 170 or the like, a transmission request for the vehicle traveling image may be transferred to the telematics server 200 through the communication module 110 so as to acquire the vehicle traveling image.

In this case, the in-vehicle telematics terminal 100 may transmit a search request to the telematics server 200 such that some sections from among the vehicle traveling sections and the imaging time corresponding to some sections can be used as the search condition and the searching operation is then carried out using the search condition in operation 2000. Referring to FIG. 8, a vehicle traveling image acquired when the vehicle 1 passes the traveling section 1 (Edge1), for example, during a specific time from 29 Oct. 2015 10:10 AM to 29 Oct. 2015 10:14 AM, is requested.

In this case, the telematics server 200 may search for the vehicle traveling image stored in the image storage 232, and may search for the vehicle traveling image by searching for index information including the traveling section (Edge1) and the image capture time (20151029:10:10 AM to 20151029:10:14 AM) in operation 2100. For example, some index information (I1) from among the index information (I) of FIG. 10 is searched for. The telematics server 200 can rapidly search for the vehicle traveling image by rapidly searching for only the summarized index information, instead of searching for the entire vehicle traveling image according to a lapse of time.

The telematics server 200 may determine whether index information from among a plurality of indexes of the vehicle traveling image stored in the image storage 232 is identical to some parts (I1) of the above-mentioned input index information, such that the telematics server 200 may recognize the presence or absence of the vehicle traveling image in operation 2200.

If the presence of the vehicle traveling image corresponding to some parts (I1) of index information including the first traveling section (Edge1) and the image capture time (20151029:10:10˜14) is determined (2200 ‘Yes’), the telematics server 200 may transmit the vehicle traveling image to the plurality of in-vehicle telematics terminals 100 having requested the corresponding vehicle traveling image in operation 2500.

If some parts (I1) of the index information including the traveling section (Edge1) and the image capture time (20151029:10:10˜14) corresponding to the search condition are not searched for (2200 ‘No’), the telematics server 200 may transmit some parts (I1) of index information including the traveling section (Edge1) and the image capture time (20151029:10:10˜14) corresponding to the search condition to the plurality of in-vehicle telematics terminals 100, and may transmit a search request related to the transmitted information in operation 2300.

The plurality of in-vehicle telematics terminals 100 having received the search request may search for some parts (I1) of index information including the traveling section (Edge1) and the image capture time (20151029:10:10˜14) corresponding to the search condition.

If the vehicle traveling image corresponding to some parts (I1) of the index information including the traveling section (Edge1) and the image capture time (20151029:10:10˜14) is searched for in at least one of the in-vehicle telematics terminals 100, at least one of the in-vehicle telematics terminals 100 having searched for the above-mentioned information may transmit the resultant signal to the telematics server 200.

If the telematics server 200 receives the above-mentioned resultant signal, a transmission request for transmitting the vehicle traveling image may be transmitted to at least one of the in-vehicle telematics terminals 100 having searched for the vehicle traveling image corresponding to some parts (I1) of the index information including the traveling section (Edge1) and the image capture time (20151029:10:10˜14) in operation 2400.

The telematics server 200 may receive the vehicle traveling image from at least one of the in-vehicle telematics terminals 100 having searched for the vehicle traveling image corresponding to some parts (I1) of the index information including the traveling section (Edge1) and the image capture time (20151029:10:10˜14) contained in the search condition, and may transmit the associated vehicle traveling image to at least one of the in-vehicle telematics terminals 100 in operation 2500.

The above-mentioned embodiments have exemplarily disclosed the in-vehicle telematics terminal, the telematics server, the telematics system, and the method for controlling the in-vehicle telematics terminal, the telematics server, the telematics system, which can store a vehicle traveling image and index information regarding the vehicle traveling image, can quickly search the corresponding vehicle traveling image by searching the index information, and can transmit and receive the vehicle traveling image to and from the terminal or server having generated the vehicle traveling image transmission request.

As is apparent from the above description, the in-vehicle telematics terminal, the telematics server, the telematics system, and the method for controlling the same according to the embodiments of the present disclosure can generate index information regarding the vehicle traveling image using metadata of the vehicle traveling image, and can transmit the index information to the telematics server. The telematics server receives a vehicle traveling image and index information of the vehicle traveling image from a vehicle including the telematics terminal, and stores the received vehicle traveling image. Upon receiving a request regarding a specific vehicle traveling image, the telematics server can quickly search for the vehicle traveling image by searching for index information of the vehicle traveling image. In addition, the telematics server can transmit such vehicle traveling image to at least one of the plurality of in-vehicle telematics terminals having transmitted a vehicle traveling image request.

Although the above-mentioned embodiments of the present disclosure have been disclosed herein merely for illustrative purposes, the scope or spirit of the embodiments is not limited thereto, and those skilled in the art will appreciate that various modifications, additions and substitutions are possible, without departing from the scope and spirit of the disclosure as disclosed in the accompanying claims. For example, adequate effects of the present disclosure may be achieved even if the foregoing processes and methods may be carried out in different order than described above, and/or the aforementioned elements, such as systems, structures, devices, or circuits, may be combined or coupled in different forms and modes than as described above or be substituted or switched with other components or equivalents.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. An in-vehicle telematics terminal comprising:
a storage configured to store a vehicle traveling image;
a metadata generator configured to generate metadata of the vehicle traveling image;
an index information generator configured to generate index information of the vehicle traveling image using the metadata of the vehicle traveling image, wherein the index information includes a traveling section and an image capture time corresponding to the traveling section; and
a communication module configured to transmit the generated index information to a telematics server or to transmit some parts of the index information corresponding to a search condition requested by the telematics server.

2. The in-vehicle telematics terminal according to claim 1, wherein the metadata of the vehicle traveling image includes not only information regarding an image capture position of the vehicle traveling image but also information regarding an image capture time at which the vehicle traveling image is captured.

3. The in-vehicle telematics terminal according to claim 1, wherein the traveling section includes a road section between a first point and a second point where a vehicle travels.

4. The in-vehicle telematics terminal according to claim 1, wherein the image capture time includes date and time information during which the vehicle travels in the traveling section.

5. The in-vehicle telematics terminal according to claim 1, wherein the search condition includes some sections of the traveling section and an image capture time corresponding to the some sections.

6. A telematics server comprising:
an information transmission/reception (Tx/Rx) server configured to transmit and receive a vehicle traveling image and index information of the vehicle traveling image to and from a plurality of in-vehicle telematics terminals;
an image storage configured to store the vehicle traveling image and index information of the vehicle traveling image; and
an index information search module, and upon receiving a search request for searching for some parts of the index information corresponding to a search condition from among the plurality of index information from at least one of the in-vehicle telematics terminals through the information transmission/reception (Tx/Rx) server, the index information search module configured to search for the some parts of the index information.

7. The telematics server according to claim 6, wherein if some parts of the index information corresponding to the search condition is searched for by the index information search module, the information transmission/reception (Tx/Rx) server transmits the vehicle traveling image corresponding to the searched some parts to at least one of the in-vehicle telematics terminals having generated the search request for searching for the some parts of the index information.

8. The telematics server according to claim 6, wherein if some parts of the index information corresponding to the search condition are not searched for, the information transmission/reception (Tx/Rx) server transmits a transmission request for transmitting the vehicle traveling image corresponding to the some parts of the index information to at least one of the in-vehicle telematics terminals including the some parts of the index information.

9. The telematics server according to claim 6, wherein the index information of the vehicle traveling image includes index information of the vehicle traveling image, where the index information includes a traveling section and an image capture time corresponding to the traveling section.

10. The telematics server according to claim 9, wherein the traveling section includes a road section between a first point and a second point where a vehicle travels.

11. The telematics server according to claim 9, wherein the image capture time includes date and time information during which the vehicle travels in the traveling section.

12. The telematics server according to claim 6 wherein the search condition includes some sections of the traveling section and an image capture time corresponding to the some sections.

13. A telematics system comprising:
a plurality of in-vehicle telematics terminals configured to transmit and receive a vehicle traveling image and index information of the vehicle traveling image to and from a telematics server; and
a telematics server configured to store the vehicle traveling image received from the plurality of in-vehicle telematics terminals and index information of the received vehicle traveling image, and configured to, upon receiving a transmission request for transmitting the vehicle traveling image and some parts of the index information of the vehicle traveling image from at least one of the in-vehicle telematics terminals, search for the some parts of the index information of the vehicle traveling image, and transmit the vehicle traveling image corresponding to the search result.

14. A method for controlling an in-vehicle telematics terminal comprising:
storing a vehicle traveling image;
generating metadata of the vehicle traveling image;
generating index information of the vehicle traveling image using the metadata of the vehicle traveling image, wherein the index information includes a traveling section and an image capture time corresponding to the traveling section; and
transmitting the generated index information to a telematics server, or transmitting some parts of the index information corresponding to a search condition requested by the telematics server.

15. The method according to claim 14, wherein the metadata of the vehicle traveling image includes not only information regarding an image capture position of the vehicle traveling image but also information regarding an image capture time at which the vehicle traveling image is captured.

16. The method according to claim 14, wherein the traveling section includes a road section between a first point and a second point where a vehicle travels.

17. The method according to claim 14, wherein the image capture time includes date and time information during which the vehicle travels in the traveling section.

18. The method according to claim 14, wherein the search condition includes some sections of the traveling section and an image capture time corresponding to the some sections.
